(19) United States
(12) Patent Application Publication
(10) Pub. No.: US 2010/0312608 A1
(43) Pub. Date: Dec. 9, 2010

(54) CONTENT ADVERTISEMENTS FOR VIDEO

(75) Inventors: YING SHAN, Sammamish, WA (US); XU LIU, Beijing (CN); JUNXIAN WANG, Redmond, WA (US); HUAZHONG NING, Redmond, WA (US); JIAYUAN HUANG, Sammamish, WA (US); ASHISH GUPTA, Bothell, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/479,428

(22) Filed: Jun. 5, 2009

(51) Int. Cl. G06Q 30/00; G06Q 99/00; G06F 17/30; G06F 3/01

(52) U.S. Cl. 705/10; 705/26; 707/E17.108; 715/719; 705/14.66

(57) ABSTRACT

Described herein are techniques and components for displaying a text advertisement in an online video being viewed by a user. The advertisement is selected based on keywords associated with the online video or the user, and the selected advertisement is presented as an overlay on the rendered video over regions of frames determined to be less important in the video. To determine importance, every frame of the online video is divided into grids, and parameters of the visual data in each grid are analyzed. Based on the analysis of each grid, regions in successive frames are identified to display the selected advertisement.

### BACKGROUND

Many advertisers are noticing the abundance of videos on the World Wide Web (“web”) and consequently turning to the web as a viable medium to display advertisements. To try and reach users on the web, advertisements are being injected into web videos. For instance, a web video may play a commercial before the video begins. Back-end software typically handles the selection (e.g., through bidding by advertisers) and presentation of advertisements in web or online videos.

Because web users are inundated with advertisements in various forms, advertisements on the web need to have a number of qualities to be effective. An advertisement should be targeted to the right type of user, taking into account user profiles, demographics, geography, and other relevant user qualities. The degree to which the displayed advertisement is disjointed or interrupts surrounding web content (i.e., the intrusiveness of the displayed advertisement) can also influence the effectiveness of a advertisement. In addition, the attractiveness of the advertisement can make a large difference in click-through rates.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One aspect of the invention is directed to displaying a text advertisement in an online video viewed by a user. Once the user requests to view the online video, various software-encoded components work to select an advertisement, select an overlay template, and identify regions in frames of the online video to display the advertisement in the overlay template. Keywords describing the online video, the user, or both are used to select the advertisement. The overlay template is selected from a database of published templates based on compatibility with the advertisement. Additionally, frames of the video are analyzed to find successive frames with regions suitable to display the advertisement in a manner non-intrusive to the online video. A file is eventually transmitted back to the computing device to instruct a web browser plug-in to render the online video with the selected advertisement as an overlay in the selected advertisement template.

Another aspect is directed to analyzing an online video to locate regions that are non-intrusive to the visual data being conveyed by the online video. These non-intrusive regions are referred to below as low attentive regions (LARs). Analysis of the video includes dividing each frame into grids, and analyzing the color, contrast, gradient information, or motion of objects in the visual data of each grid. LAR scores are assigned to each grid indicating the importance of the visual data in each grid. The LAR scores are analyzed to identify LARs in successive frames for a given time span for displaying the advertisement.

Another aspect is directed to a user interface (UI) display that presents an overlay UI area in front of rendered frames of an online video. The overlay UI area includes an advertisement template displaying a selected advertisement. The frames and placement regions in the frames for the overlay UI are selected by analyzing the color, contrast, motion, or gradient information of all the frames of the online video.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing device, according to one embodiment;

FIG. 2 is a diagram of a user interface (UI) for displaying an advertisement in an online video, according to one embodiment;

FIG. 3 is a diagram of a networking environment for displaying an advertisement in an online video, according to one embodiment;

FIG. 4A is a diagram of an online video frame divided into non-overlapping grids, according to one embodiment;

FIG. 4B is a diagram of LAR scores of an online video frame divided into grids, according to one embodiment;

FIG. 5 is a diagram of a three-dimensional representation of an online video, according to one embodiment;

FIGS. 6A-6B are diagrams of Uls displaying advertisements being displayed in an online video, according to one embodiment; and

FIG. 7 is a diagram of a flow chart depicting software-encoded steps for displaying an advertisement in an online video, according to one embodiment.

### DETAILED DESCRIPTION

The subject matter described herein is presented with specificity to meet statutory requirements. The description herein is not intended, however, to limit the scope of this patent. Instead, the claimed subject matter may also be embodied in other ways, to include different steps or combinations of steps similar to the ones described in this document, in conjunction with other present or future technologies.

In general, embodiments described herein are directed to displaying advertisements in web videos, which are referred to herein as “online videos.” When a user attempts to play an online video, an advertisement is carefully selected for display within the online video. The advertisements are spliced into the online video and presented in a UI overlay over a portion of the online video. Placement of the advertisement in the online video is determined by analyzing each frame of the online video to identify an optimal set of frames and an optimal position within the frames to position the advertisement. Optimal placement of the advertisement is generally within a trivial, stagnate, or non-important portion of the online video (e.g., the sky shown during various scenes of the video) to ensure the advertisement is not intrusive of the online video.

In one embodiment, the online video is divided into multiple frames. A frame, as referred to herein, is a single image of the online video at a particular point in time. To determine where to place advertisements within the online video, in one embodiment, individual frames of the advertisement are analyzed to find LARs within the frames. While discussed in more detail below, color content, gradient information and motion parameters may be taken into account to determine LARs within frames.

A set of successive frames with the same or similar LARs for an amount of time an advertisement should be displayed are identified. For example, an advertisement may be required to be displayed for five seconds. To do so, the frames of a selected video may be analyzed for a group of successive frames spanning five seconds with LARs in the same position. Different reasons may exist for the time constraints for displaying the advertisement—e.g., requirements of a particular advertiser or bidding factors during an online advertising bidding process.

Before proceeding further, some key definitions should be discussed. First, an “online video” is a video accessible over a network, such as the Internet. Online videos may be requested from users accessing web pages and presented in a web browser window. For example, a web page may include an online video and provide a user the opportunity to press a play button. Alternatively, online videos may come in the form of downloaded videos presented over a cable network in an on-demand fashion. In another alternative, online videos may be shared between computing devices in a peer-to-peer fashion over a network. Moreover, online videos may be streamed to a computing device or downloaded as a file.

Second, an “advertisement,” as referred to herein, is a web-based advertisement containing text. Advertisements may include animation and hyperlinks to additional web content (e.g., a link to a particular web page about a product). In one embodiment, the advertisement comprises text for display, while an advertisement template specifies the configurable parameters (e.g., font, size, color, and the like) and animation for the presentation of the advertisement. Aside from text, advertisements in alternative embodiments may also display various images, audio, or video. As discussed in more detail below, advertisement templates may be created by “template publishers,” who are users that develop different types advertising templates.

An “advertisement template” is a display area consisting of multiple text boxes and animation understood by a plug-in (e.g., Microsoft SilverLight™ or Adobe Flash) to a web browser. Additionally, an advertisement template may include limits on the template parameters, such as font type, text size, etc. These limits may be set by the template publisher who designed a given advertisement template.

Embodiments mentioned herein may take the form of a computer-program product that includes computer-useable instructions embodied on one or more computer-readable media. Computer-readable media include both volatile and nonvolatile media, removable and nonremovable media, and contemplates media readable by a database. The various computing devices, application servers, and database servers described herein each may contain different types of computer-readable media to store instructions and data. Additionally, these devices may also be configured with various applications and operating systems.

By way of example and not limitation, computer-readable media comprise computer-storage media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read-only memory (ROM), electrically erasable programmable read-only memory (EEPROM), flash memory used independently from or in conjunction with different storage media, such as, for example, compact-disc read-only memory (CD-ROM), digital versatile discs (DVD), holographic media or other optical disc storage, magnetic cassettes, magnetic tape, magnetic disk storage, or other magnetic storage devices. These memory devices can store data momentarily, temporarily, or permanently.

Various techniques are performed by web-based services that support interoperable machine-to-machine interaction over a network. For the sake of clarity, the server-based web services described herein are referred to as “components.” Components may operate in a client-server relationship to carry out various techniques described herein. Such computing is commonly referred to as “in-the-cloud” computing. To support components, servers may be configured with a server-based operating system (e.g., Microsoft Windows Server®), server-based database software (e.g., Microsoft SQL Server®), or other server-based software.

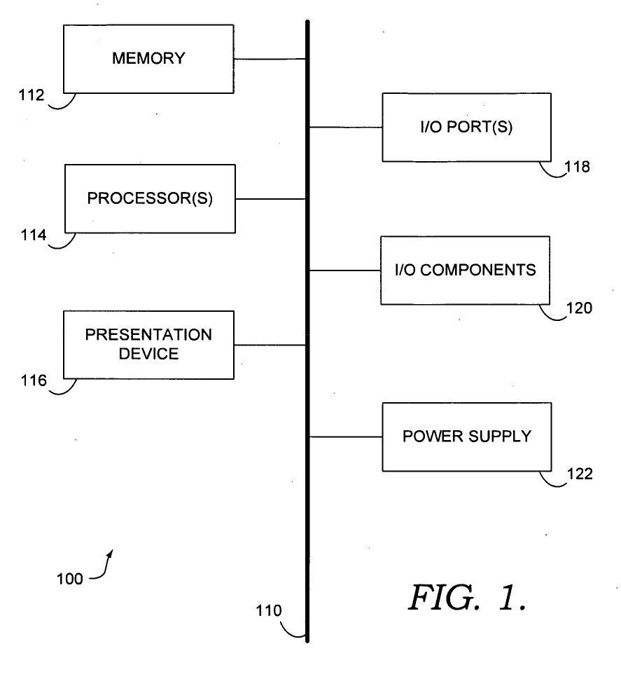

Having briefly described a general overview of the embodiments described herein, an exemplary operating environment is described below. Referring initially to FIG. 1 in particular, an exemplary operating environment for implementing one embodiment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of illustrated component parts. In one embodiment, computing device 100 is a personal computer. But in other embodiments, computing device 100 may be a cell phone, smartphone, digital phone, handheld device, BlackBerry®, personal digital assistant (PDA), or other device capable of executing computer instructions.

Embodiments may be described in the general context of computer code or machine-useable instructions, including computer-executable instructions such as program modules, being executed by a computer or other machine, such as a PDA or other handheld device. Generally, machine-useable instructions define various software routines, programs, objects, components, data structures, remote procedure calls (RPCs), and the like. In operation, these instructions perform particular computational tasks, such as requesting and retrieving information stored on a remote computing device or server.

Embodiments described herein may be practiced in a variety of system configurations, including handheld devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation device 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various hardware is not so clear, and metaphorically, the lines would more accurately be grey and fuzzy. For example, one may consider a presentation device, such as a monitor, to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 may include a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation device 116 presents data indications to a user or other device. Exemplary presentation components include a display device, speaker, printing component, vibrating component, etc.

Specifically, memory 112 may be embodied with instructions for a web browser application, such as Microsoft Internet Explorer®. One skilled in the art will understand the functionality of web browsers; therefore, web browsers need not be discussed at length herein. It should be noted, however, that the web browser embodied on memory 112 may be configured with various plug-ins (e.g., Microsoft SilverLight™ or Adobe Flash). Such plug-ins provide enable web browsers to execute various scripts or mark-up language in communicated web content. For example, a JavaScript may be embedded within a web page and executable on the client computing device 100 by a web browser plug-in.

I/O ports 118 allow computing device 100 to be logically coupled to other devices including I/O components 120, some of which may be built in. Illustrative components include a microphone, joystick, game pad, satellite dish, scanner, printer, wireless device, etc.

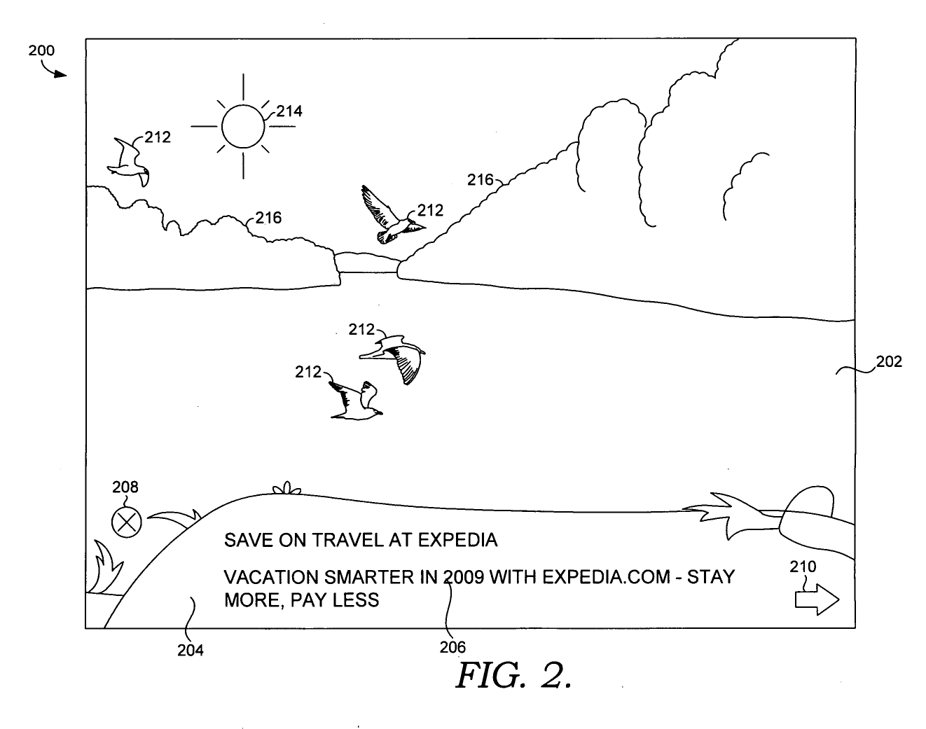

FIG. 2 is a diagram of a UI for displaying an advertisement in an online video, according to one embodiment. The UI, referenced as UI 200, illustrates a rendered frame 202 of an online video with an advertisement overlay 204 displayed in a display area over a portion of the rendered frame 202. One skilled in the art will understand that the rendered frame 202 may actually be displayed within a web page being presented in a web browser window of a client computing device. As depicted, the advertisement overlay 204 contains text 206 for an advertisement—in the illustrated case, an advertisement for the travel company Expedia®—as well as a close button 208 and a link 210. The link 210 provides an avenue to retrieve additional web content about the advertisement.

The advertisement overlay 204 is presented over an LAR of the rendered frame 202. The LAR may be selected, by components operating on a server, based on the seemingly trivial information within the LAR. For instance, the LAR of UI 200 was selected because the LAR did not include the illustrated birds 212, sun 214, and trees 216. In one embodiment, the LAR was identified by analyzing the color, motion, and other visual data in the rendered frame 202.

To understand motion-like the movement of the birds 212—visual data of subsequent frames may be analyzed by the server components. For example, the position of the birds 212 in a preceding frame compared to the birds 212 in the rendered frame 202 may indicate an object in the online video is moving, and therefore, the regions of the online video showing the movement are not optimal LARs for displaying the advertisement overlay 204.

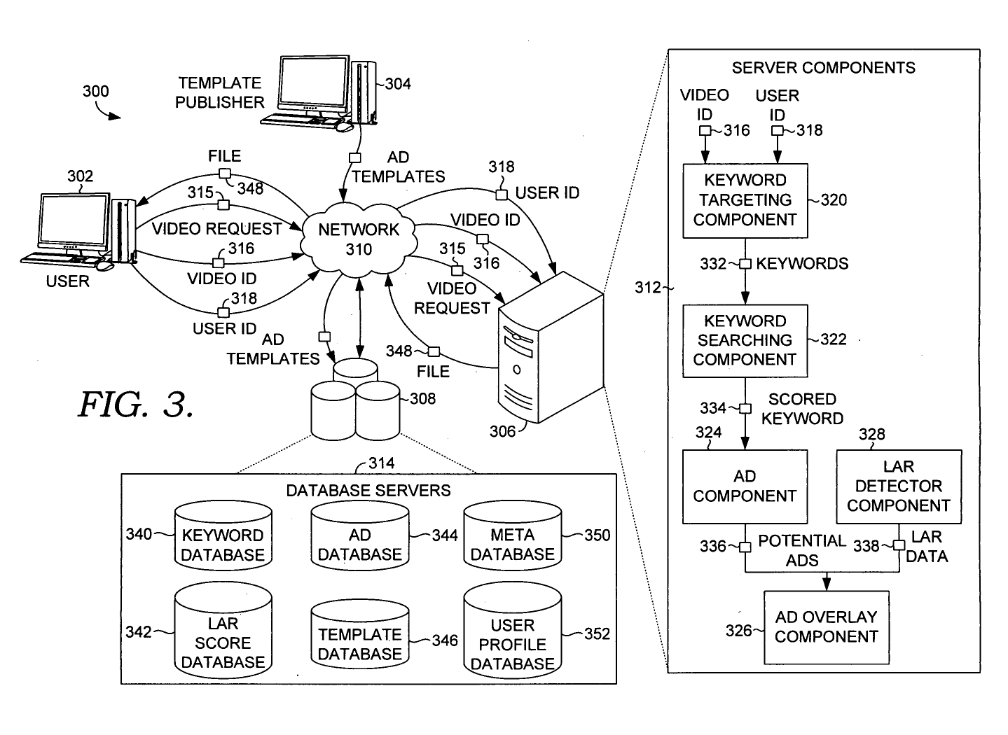

FIG. 3 is a diagram of a networking environment for displaying an advertisement in an online video, according to one embodiment. The network environment, referenced as network 300, includes several computing devices and server-based components exchanging information over a network, such as the Internet. Specifically, client computing devices 302 and 304, application server 306, and database cluster 308 communicate across network 310.

Client computing devices 302 and 304 may be any type of computing device, such as the device 100 described above with reference to FIG. 1. By example, without limitation, client computing devices 302 and 304 may each be a personal computer, desktop computer, laptop computer, handheld device, mobile phone, or other personal computing device. In particular, client computing devices 302 and 304 may be configured with web browsers and the aforesaid web browser plug-ins.

Specifically, a user operates computing device 302, and a template publisher operates computing device 304. With reference to FIG. 3, a “user” someone attempting to play an online video. A “template publisher” is someone who uploads advertisement templates for use in displaying advertisements in online videos. The template publisher designs an overlay UI template with various parameters that can be used to display advertisements in online videos. Parameters of the overlay UI template may include, for example but without limitation, font, text size, animation, linked web content (e.g., links to other web pages), icons, and other configurable options. The created overlay UI template is stored in a template database 346 for the application server 306 to retrieve. Moreover, these parameters may be encoded in a scripting language, mark-up language, or other computer-readable instructions.

The application server 306 represents a server (or servers) configured to execute different web-service software components 312. Application server 306 includes a processing unit and computer-readable media storing instructions to perform the server components 312. While application server 306 is illustrated as a single box, one skilled in the art will appreciate that the application server 306 may be scalable. For example, application server 306 may actually include multiple servers operating various portions of the server components 312. Alternatively, application server 308 may act as a broker or proxy server for any of the server components 312. Many computations are performed by the application server 306 in communication with the database servers 314. In one embodiment, the application server 306 performs three key services, notably keyword extraction, LAR detection, and template design.

Database cluster 308 represents one or more database servers 314 configured to store various data. One skilled in the art will appreciate that the database servers 314 each includes a processing unit, computer-readable media, and database-server software, such as Microsoft SQL Server®. One skilled in the art will appreciate that applications developed in database computer languages may be designed for the management of data in relational database management systems (or “RDBMS”).

The network 310 may include any computer network, for example the Internet, a private network, local area network (LAN), wide area network (WAN), or the like. When network 310 comprises a LAN networking environment, components may be connected to the LAN through a network interface or adaptor. In an embodiment where the network 310 provides a LAN networking environment, components may use a modem to establish communications over the WAN. The network 310 is not limited, however, to connections coupling separate computer units. Instead, the network 310 may also include subsystems that transfer data between a server computing devices. For example, the network 310 may include a point-to-point connection. Computer networks are well known to one skilled in the art, and therefore do not need to be discussed at length herein.

In operation, the user submits a video request 315 for an online video over network 310. To do so, the user may select a play button on an online video presented in a web page, order an in-demand online video, initiate downloading the online video, or otherwise attempt to access the online video. The video request 315 may be submitted using the hypertext transfer protocol (HTTP), file transfer protocol (FTP), secure socket layer (SSL), or other type of communications protocol.

Although not shown in FIG. 3 for the sake of clarity, the video request 315 may eventually be communicated to a hosting server responsible for hosting the online video or web page the user is accessing. One skilled in the art will understand that various servers and computing devices may alternatively be used to request and deliver online videos. For example, a domain name system server (“DNS server”) may translate a requested uniform resource locator (“URL”) into an Internet Protocol address (“IP address”) where the online video content is located. Other such devices are well known to one skilled in the art, and therefore do not need to be discussed at length herein.

In one embodiment, client computing device 302 submits video identifiers (“video id 316”) and user identifiers (“user id 318”). Video id 316 comprises metadata describing the online video selected by the user. Examples of the metadata contained within video id 316 include, for example but without limitation, title, transcript, description, tag, surrounding text on a web page, length, keywords, date, time of submission, globally unique identifier (GUID), global video unique identifier (vGUID), and other information related to the online video. For online videos that contain captions, the captions may be understood and translated into keywords using optical character recognition (“OCR”) software. The keywords of the video id 316 indicate words or phrases that describe the content of the online video. For example, an online video about a breed of dog may have metadata identifying the type of dog.

User id 318 comprises data about the user, such as user profile, web history, user keywords, geographic location, age, and other user-specific data. With respect to a user profile, the user id 318 may include keywords, or indications of keywords, that specify the user's age, geographic location, interests, hobbies, affiliations, web associations (e.g., online groups), relationships to other users, and the like. Additionally, these user keywords may include text entered by a user onto a web page (e.g., a search engine). In one embodiment, user id 318 takes the form of submitted cookies that identify the aforesaid data about the user.

The video id 316 and the user id 318 are communicated to the application server 306, which executes the server components 312. Server components 312 include a keyword targeting component 320, keyword searching component 322, ad component 324, ad overlay component 326, and LAR detector component 328. Each server component represents software configured to perform the techniques mentioned below. Additional or alternative server components may be used in different embodiments.

In one embodiment, the keyword targeting component 320 receives the video id 316 and the user id 318 and queries a keyword database 340 storing keywords related to the online video and the profile of the user, respectively. Additionally, the keyword targeting component 320 may access a meta database 348, which stores metadata associated with different online videos. For example, the keyword targeting component 320 may identify the subject matter of the online video by analyzing the captions, title, associated tags, of the online video. For the profile of the user, the keyword database 340 may access a user profile database 352 for historical data about the user, such as geographic locations, interests, hobbies, affiliations, web associations (e.g., online groups), relationships to other users, and the like. In an alternative embodiment, the keyword targeting component 320 extracts the keywords 332 from the web page providing the online video. For example, the text of the web page may be parsed for the keywords 332 to identify the context of the online video.

In one embodiment, the keyword searching component 322 receives keywords about the video id 316 or user id 318 and produces scored keywords 334 by assigning confidence scores to the keywords 332. Confidence scores reflect the weight assigned to each of the keywords 332 based on different advertisement-targeting agendas (e.g., content-based targeting or user-based targeting) geared towards maximizing the relevance of an advertisement or the revenue generated from the advertisement. In one embodiment where advertisements are targeted based on the context of the online video, the keywords 332 returned for the video id 316 are scored with greater deference than the keywords 332 returned for the user id 318. Alternatively, when advertisements are to be focused on the user, the keywords 332 returned for the user id 318 are scored with greater deference than the keywords 332 returned for the video id 316. Various software-implemented algorithms may be used to actually score the scored keywords 334.

The ad component 324 uses the scored keywords 334 to query the ad database 334 for potential advertisements 336. Because the scored keywords 334 are weighted, the potential advertisements 336 may, in effect, be directed toward either the underlying context of the online video, the user, or a combination of both. For example, the scored keywords 344 may result in the potential advertisements 336 selected from the ad database 344 including advertisements about a particular product the user was previously searching for. In another example, the scored keywords 334 may result in the potential advertisements 338 being contextually related to the title of the online video. The scored keywords 338 thus provide myriad ways to select the potential advertisements 336.

In one embodiment, advertisements returned to the ad component 324 are ranked based on a matching score indicative of the closeness of an advertisement's metadata to the video id 316, user id 318, or both; a click-through rate for the advertisement; or a monetary bid from the publisher of the advertisement. In this embodiment, the potential advertisements 336 only include the top-ranked advertisements, or more accurately, the advertisements ranked above a certain threshold. The ad overlay component 326 selects the top one or more of the potential advertisements 336 (referred to herein as the “selected advertisement”) to display in the online video. In an alternative embodiment, multiple advertisements may be selected from the potential advertisements 336 and shown within the ad overlay component 326. For the sake of clarity, however, embodiments are described herein as showing only one of the potential advertisements 336.

The ad overlay component 326 uses a machine-learning algorithm to train a software-based model that estimates LAR scores for every possible advertisement placement region in each frame of the online video. The LAR scores may be based on the contrast, color, gradient information, and motion associated with visual data in frames of the online video. In particular, gradient information refer to the smoothness of visual data in a region—i.e., whether the region contains many lines or edges.

The ad overlay component 326 receives the potential advertisements 336 and obtains the LAR scores for the online video and template information of uploaded advertisement templates in the template database 346. In one embodiment, the ad overlay component 326 uses all three inputs (i.e., potential advertisements 336, LAR scores, and template information) to select an optimal advertisement from the potential advertisements 336 (referred to herein as “the selected advertisement”), an optimal advertisement template, and an optimal placement region in the online video for the optimal advertisement templates. In short, the ad overlay component 326 determines the advertisement, template, and placement region for the advertisement in the online video. This triplet of data is packaged into a file 348 (e.g., XML, HTML, etc.), and transmitted to the client computing device 302 as video and ad file 318. Upon receipt of the file 348, the client computing device 302 will download the template from the template database 346, and then overlay the selected advertisement with the optimal advertisement template of the LAR into the online video.

The optimal placement region refers to the area in a group of successive frames where the selected advertisement is overlaid on the optimal advertisement template. The optimal placement region includes coordinates for displaying the selected advertisement in the optimal advertisement template. Also, the optimal placement region indicates a time span within the online video to display the selected advertisement in successive frames. For example, the optimal placement region may specify to overlay the selected advertisement in the optimal advertisement template over the top 1/10^{th} of each frame from minute five to minute six of the online video.

The overlay component 326 also determines an optimal advertisement template stored in the template database 346. In one embodiment, the selected advertisement and the advertisement template are selected by computing which advertisement template in the template database 346 has the best combination of two constraints, a non-intrusive region and template compatibility with the advertisement.

To determine the compatibility of an advertisement template with the selected advertisement, the ad overlay component compares the size of the text in the selected advertisement to the template parameters of the advertisement template. Advertisement templates using larger font sizes to display the selected advertisement may be preferable, in some embodiments, when the font size is within a size-range specified by the designing template publishers. In other embodiments, the advertisement template with the smallest unfilled space for the selected advertisement may be preferred when the selected advertisement text is relatively short. Additionally, for the selected advertisement with longer amounts of text, the advertisement template may be selected based on the amount of text needing cut for display. For example, the advertisement template that needs to cut half the text of the selected advertisement may not be selected over another advertisement template that only cuts a third of the text. The ad overlay component 326 may alternatively use other template parameters to select the correct advertisement template.

The LAR detector component 328 determines optimal frames of online videos and the optimal placement regions to place advertisements in the optimal frames. The LAR detector component 328 may operate independently of the other server components 312, constantly analyzing different online videos for LARs and storing LAR scores in the LAR score database. In short, the LAR detector component 328 analyzes the online video frame by frame. In one embodiment, the LAR detector component 328 determines the LAR data 338 for the online video. The LAR data 338 comprises the determined LARs and LAR scores (explained below) and is stored in the LAR score database 342.

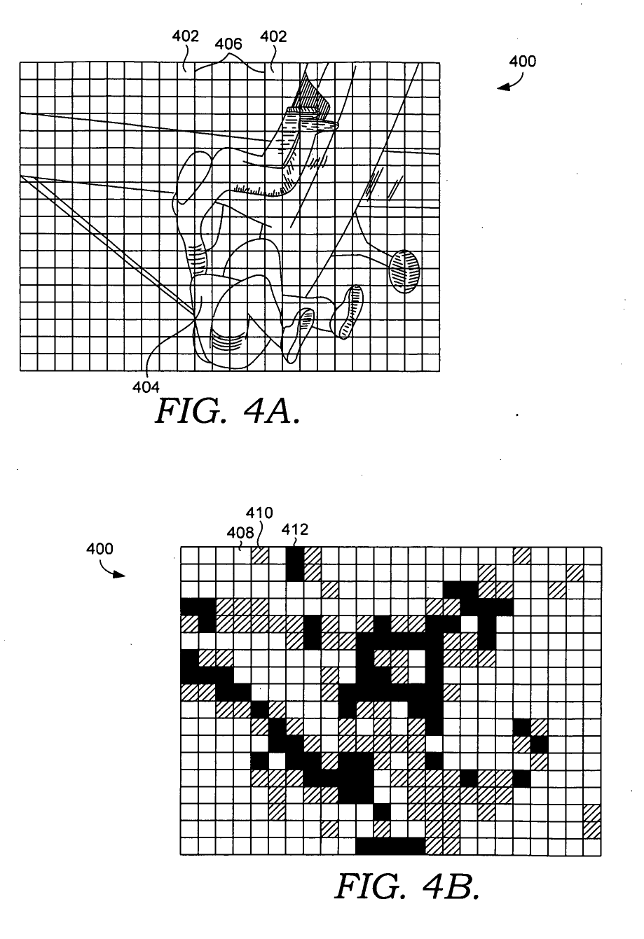

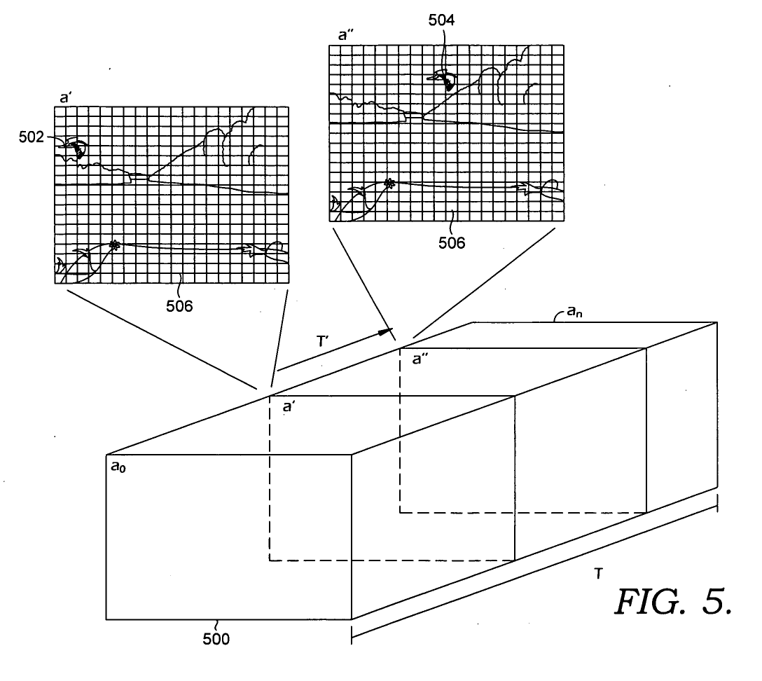

Creation of the LAR data 338 is described in more detail below in reference to FIGS. 4A, 4B, and 5. FIG. 4A illustrates a diagram of an online video frame 400 showing visual data divided into grids, according to one embodiment. To obtain LAR data 338, each frame of the online video is divided into grids 406 and each grid 406 encompasses a portion of visual data 402 in the frame 400. Grids, as referred to herein, are numerous sections of a frame, not a collection of parallel and perpendicular lines. FIG. 4A has numerous grids (432 in total) created by the parallel and perpendicular lines dividing the frame 400. Each grid 406 includes some visual data 402 of the frame 400. To clarify, reference numeral 406 points to two grids 406, each of which includes different visual data 402.

Frame 400 shows grids 406 different spatial regions. The grids 406, in one embodiment, are large enough to be perceived by the human eye. Once the frame 400 is divided into the grids 406, a software-implemented LAR detection technique (“LAR technique”) is performed on each of the grids 406 or the pixels therein. The detection technique analyzes and measures a number of visual data parameters, including the contrast, color, motion, and gradient information in each grid 406. For motion, the color, contrast, or gradient information in a grid 406 may be compared with the color, contrast, or gradient information for a grid in a previous or subsequent frame. One goal of the LAR technique is to identify LARs in the visual data of the frame 400.

In one embodiment, the LAR technique applies a Gaussian filter to the visual data in a grid 406 and computes the difference between the resultant Gaussian value and the original visual data. In other words, the LAR technique applies a difference of Gaussian (DOG) filter, defined by subtracting a wide Gaussian from a narrow Gaussian, as shown in the following formula:

D(x,y)=(1/σ\sqrt{2π}))exp(−(x²+y² )/2a²)−(1/(ka\sqrt{2π})exp(−(x²+y²)/2(ka)²)

The convolution of the original visual data in the frame 400 convoluted with the DOG filter D(x,y) produces a contrast map defined by the following formula:

c(x,y)=I(x,y)*D(x,y)

Within each of the grids 406, the LAR technique calculates the mean and variance of the pixel contrasts, denoted as m_{c} and v_{c}, respectively.

The LAR technique may assume LARs have less object motion, because a moving object in an online video is usually somewhat important. In one embodiment, the LAR technique computes the mean (mᵥ) and variance (vᵥ) of a motion magnitude for a grid 406 by comparing previous or subsequent frames. In one embodiment, the LAR technique builds a bin-orientation histogram (H) spanning 0 to π. Each pixel in a grind 406 softly votes with respect to its motion orientation, weighted by the motion magnitude. In one embodiment, motion entropy (Eₘ) is figured by calculating the following integral from 0 to π:

Eₘ=∫−Hₘ(o)log Hₘ(o)do

Eₘ reflects the chaos of pixel motions and is therefore used by the LAR technique to determine whether a grid 406 or pixel contains a high level of motion or no motion at all. In one embodiment, the motion scores reflect the degree of motion chaos in pixels or grids 406. Alternatively, the motion scores only represent a lack of motion (0) or detection of motion (1). In this alternative embodiment, a threshold value of Eₘ may be used by the LAR technique to determine whether detected motion exceeds an acceptable range.

For gradient information, the LAR technique assumes a smooth grid 406 is more likely to be an LAR than a grid 406 with many lines and edges. In other words, grids 406 with small gradients are more likely to be LARs in some embodiments. Like the LAR technique did for motion, in one embodiment, the mean (m_{gr}) and variance (v_{gr}) of gradient magnitudes are computed, and a gradient orientation histogram is build to obtain gradient entropy (E_{gr}). E_{gr} represents the chaos of lines and edges and, to some extent, the existence of textures in a grid 406.

For color detection, the LAR technique may perform the following computations. The LAR technique retrieves an entire frame 400 of visual data with colors distributed as p(r, g, b), where (r, g, b) is a point in the RGB color space. For a specific pixel with color (r₀, g₀, b₀), the LAR technique assumes a small amount of color (referenced as p(r₀, g₀, b₀)) probably belongs to the foreground of the frame 406. The LAR technique computes −log p(r₀, g₀, b₀) for every pixel in a grid 406 and summarizes the results to accurately represent the visual data contained in the grid 406. This summarization (referred to as E_{ci}) represents the color entropy across a grid 406. Besides the color entropy, the LAR technique may also compute the mean (mᵣ, m_{g}, and m_{b}) and variance (vᵣ, v_{g}, and v_{b}) of each color channel in the grid 406.

In one embodiment, the LAR technique prepares the following vector (v) to represent the color features in a grid 406.

v{m_{c}, v_{c}, mᵥ, vᵥ, vᵥ, Eₘ, E_{gr}, mᵣ, vᵣ, m_{g}, v_{g}, m_{b}, v_{b}, E_{ci}}

The LAR technique may be configured to learn human labeled LAR grids, and to enable quick learning, all features in vector v may be normalized to zero mean and unit variance. In another embodiment, the LAR technique predicts a label for each new grid encountered based on vector v.

Support Vector Machine (“SVM”) models are similar to classical multilayer perception neural networks in many aspects. Actually, an SMV, using kernel functions, provides an alternate training method for multilayer perception classifier in which the network weights are obtained by solving a quadratic programming problem with linear constraints. Thus, in one embodiment, the LAR technique applies a kernel SVM with radial basis function to teach an LAR detector how to detect future LARs. Using the SVM, the LAR technique may compute a confidence score for a potential LAR score.

After the LAR technique determines LARs based on the color, motion, contrast, and gradient information, each grid 406 is given an LAR score indicative of the importance of the visual data the grid 406. For instance, high gradient entropy, color entropy, and motion entropy may indicate a grid 406 has important visual data and therefore would not be an appropriate place for an advertisement. On the other hand, low gradient entropy, color entropy, and motion entropy may indicate the visual data is relatively unimportant, thus qualifying as a better place to present an advertisement. LAR scores may vary widely in range or alternatively indicate two possibilities, important visual data and non-important visual data.

FIG. 4B is a diagram of LAR scores of the frame 400 for the grids 406, according to one embodiment. Three LAR scores are illustrated as blank grids 408, shaded grids 410, and filled grids 412. Blank grids 408 indicate LARs, i.e., grids 406 with less important visual data. Shaded grids 410 indicate somewhat important visual data was detected by the LAR technique. And filled grids 412 indicate important visual data was detected. The shaded grids 410 and the filled grids 412 map to the lines of the plane depicted in the frame 406 in FIG. 4A. Whereas, the sky in frame 400 is represented with blank grids 408.

With the LAR scores forming a map of LARs in a frame, the placement region for an advertisement can then be determined. The placement region represents both placement in successive frames of a video and the time for displaying the advertisement. FIG. 5 illustrates a diagram of a three-dimensional representation of an online video, according to one embodiment. A placement region is shown, comprising frames a′ to a″ that are displayed during a time T′. The online video itself includes frames a₀ to aₙ for time T. After analyzing every grid in every frame, the LAR technique determines frames a′ to a″ contained LARs in the same place of every frame. To make this judgment, the LAR technique analyzed LAR scores that showed an object (i.e., a flying bird) was moving from grid 502 to grid 504, thus grids 502 and 504 were not LARs. Based on color, contrast, and gradient information, display region 506 was identified as an LAR.

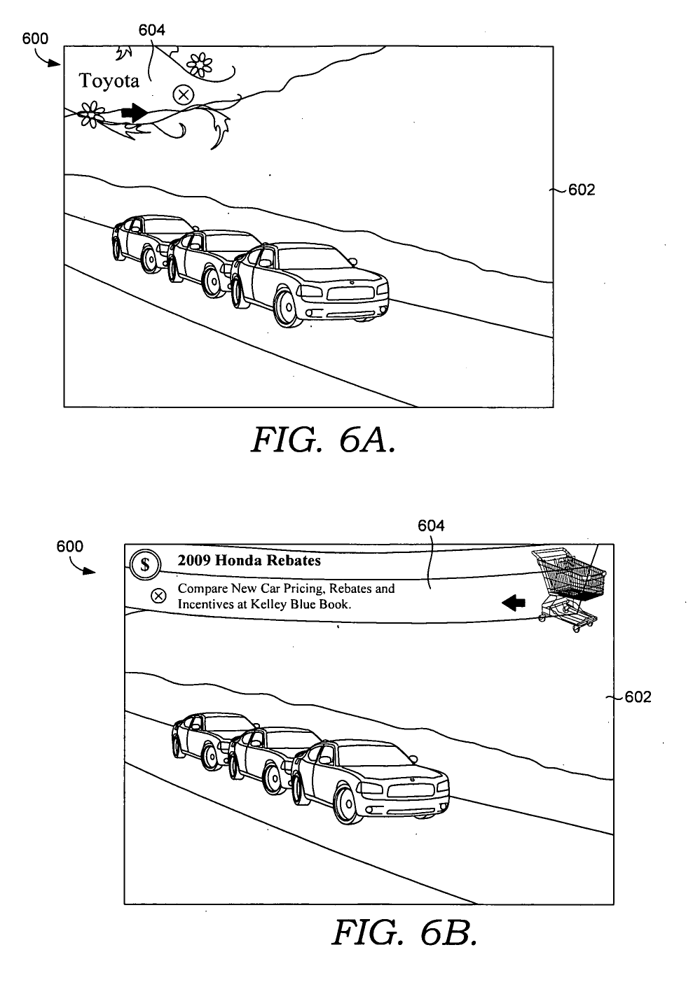

FIGS. 6A-6B are diagrams of Uls displaying advertisements being displayed in an online video, according to one embodiment. Looking initially at FIG. 6A, a frame 600 of an online video of three cars racing is displayed. The frame 600 comprises a rendered video display area 602 and an advertisement display area 604. The rendered video display area presents visual data of the online video. The advertisement display area 604 is simultaneously displayed as an overlay UI in the frame 600. The advertisement display area 604 contains an advertisement presented in an advertisement template. Moreover, the advertisement display area 604 was chosen by an LAR technique that analyzed various visual parameters of the video frame 600, such as color, contrast, motion, or gradient information. The advertisement template includes animation.

FIG. 6B shows the frame 600 with another advertisement displayed in the advertisement display area 604. In the illustrated embodiment, animation may be used to “scroll” the advertisement onto the video display area 602. One skilled in the art will appreciate that numerous types of animation may be applied to the advertisement display area 604. Alternatively, animation may be applied when the overlay UI is presented in a frame, not just when the user performs an action.

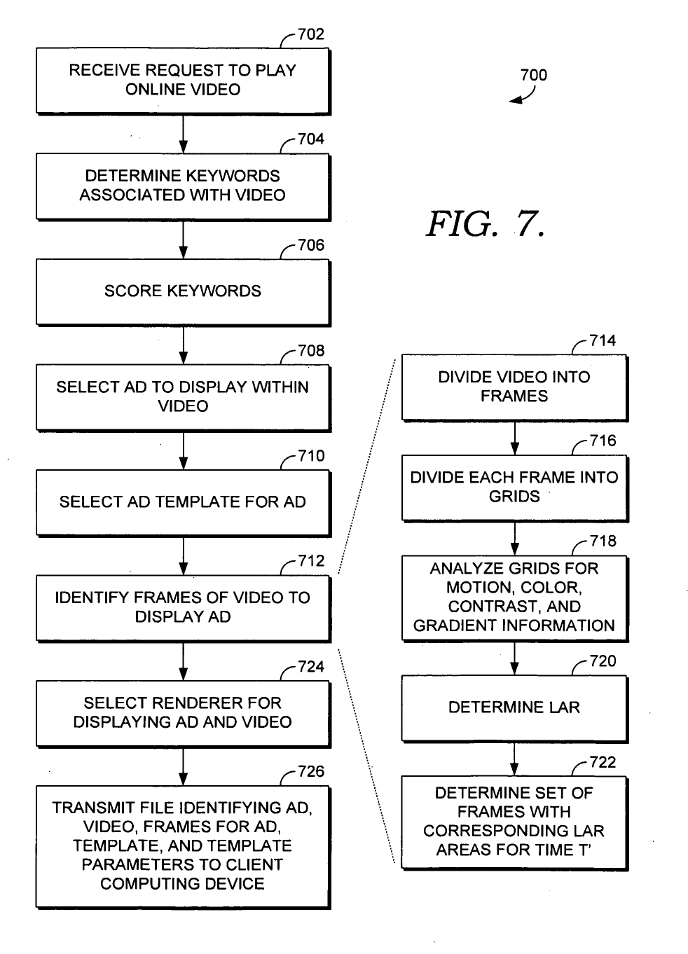

FIG. 7 is a diagram of a flow chart depicting steps, codede in software, for displaying an advertisement in an online video, according to one embodiment. Initially, a user selects an online video to play. As shown at step 702, a request to play the online video is received. Keywords associated with the video are determined, as indicated at step 704. Determination of video keywords may be performed by sifting through metadata associated with the video, for example title, tags, surround web content, etc. Alternatively, keywords about the user may be extracted, such as profile data, web history, geographic location, etc.

The determined keywords are scored, as indicated at 706, identifying certain keywords as more important for selecting potential advertisements. In one embodiment, keywords about the user are given more deference when trying to customize an advertisement to the user. Alternatively, keywords about the online video may be more important to an advertising service considering bids from advertisers. Eventually, an advertisement is selected based on the scored keywords, as indicated at 708. As indicated at 710, an advertisement template is selected for the advertisement.

The frames of the online video are analyzed to identify LARs to present the advertisement in an overlay UI window, as indicated at 712. To identify LARs, the online video is divided into frames, indicated at 714, and each frame is divided into grids, as indicated at 716. The visual data in the grids are analyzed for motion, color, contrast, and gradient information—as indicated at 718. To analyze the visual data, an LAR technique similar to the one described above may be performed. Based on the analysis of visual data, LARs are determined, as indicated at 720, and used to assign LAR scores to the grids in each frame. To find an area for the advertisement, a set of frames with corresponding LARs—“corresponding” meaning the LARs are in the same or similar grids of previous or subsequent frames—for a length of time (T′) is determined.

T′ may be determined a number of ways. In one embodiment, an owner or publisher of the advertisement may submit T′ in a bid to an advertisement service. Upon winning the bid, an agreement is struck to show the advertisement for T′. Alternatively, the length of text in the advertisement may dictate T′. For example, if the advertisement has a large amount of text, the advertisement may be shown for a longer amount of time to appeal to the user. In another embodiment, T′ is calculated based on the number of frames with corresponding LARs. Accordingly, if only x number of successive frames in an online video have LARs in the same or similar grids, T′ is based on the time for showing the successive frames.

Once frames and LARs are determined, a renderer is selected (as indicated at 724) for displaying the advertisement, online video, or both. In one embodiment, a renderer capable of rendering the video and the advertisement in the advertisement template is transmitted to a client computing device. In addition, a file identifying the advertisement, online video, frames for displaying the advertisement, and advertisement template with parameters is transmitted to the client computing device, as indicated at 726. The client computing device can then render the video, and the advertisement will be displayed in the advertisement template during time T′.

The illustrated steps are not limited to a sequential manner, as some embodiments will perform the steps in parallel or out of the sequence illustrated. Furthermore, although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims. For example, sampling rates and sampling periods other than those described herein may also be captured by the breadth of the claims.

The invention claimed is:

1. One or more computer-readable media embodied with computer-executable instructions that, when executed by a processor, perform a computer-implemented method for transmitting an advertisement for display in a video, comprising:
receiving an indication to play the video;
selecting an advertisement for presentation within the video based on one or more keywords;
dividing the video into frames;
identifying a group of successive frames over a specified time, each of the successive frames containing a low attentive region (LAR) for displaying a text-based advertisement;
acquiring an advertisement template for the text-based advertisement; and
transmitting a file containing information for displaying the text-based advertisement in the advertisement template as an overlay in the LAR of the successive frames.

2. The one or more media of claim 1, further comprising transmitting a renderer capable of rendering the video and the overlay populated with the text-based advertisement in the advertisement template.

3. The one or more media of claim 1, further comprising querying a video identifier against a keyword database to determine the one or more keywords associated with the video.

4. The one or more media of claim 1, wherein the LAR in each of the successive frames comprises a region of visual data that does not indicate motion from a corresponding region of visual data in at least one member of a group comprising a previous frame or a subsequent frame.

5. The one or more media of claim 1, wherein the advertisement template comprises at least one member of a group comprising an indication of animation and a hyperlink to web content that is contextually relevant to the text-based advertisement.

6. The one or more media of claim 1, wherein the LAR in each of the successive frames comprises a plurality of grids of visual data positioned in substantially the same area of the successive frames.

7. The one or more media of claim 1, wherein the one or more keywords are parsed from metadata associated with a video identifier.

8. The one or more media of claim 7, wherein the one or more keywords are parsed from profile data associated with a user.

10. A computer-implemented method for rendering an advertisement as an overlay over a portion of a video, comprising:
receiving a selection of the video;
selecting a text-based advertisement for display in the video;
dividing the video file into a plurality of video frames;
dividing each of the video frames into grids;
for each frame, determining a set of grids that present non-intrusive visual data of the video;
determining a length of time to display a text-based advertisement in the video;
determining correspondingly positioned grids for a quantity of successive frames spanning the length of time, wherein each of the correspondingly positioned grids presents non-intrusive visual data of the video and represents a grid likewise positioned to another grid in a previous frame; and
transmitting a file that indicates the text-based advertisement, an advertisement template, and the corresponding non-overlapping grids.

11. The computer-implemented method of claim 10, further comprising, for each of the grids, assigning a low attentive region (LAR) score based on analyzing contrast, color, and motion associated with the visual data.

12. The computer-implemented method of claim 10, wherein each of the non-overlapping grids and the correspondingly positioned grids indicate portions of the video for presentation in one of the frames.

13. The computer-implemented method of claim 12, wherein determining the set of grids that presents non-intrusive visual data of the video further comprises comparing motion indicated by a change in the visual information associated with two or more grids of successive frames.

14. The computer-implemented method of claim 13, further comprising:
comparing color of the visual information associated with the two or more grids of the successive frames; and
comparing visual patterns of the visual information associated with the two or more grids of the successive frames.

15. The computer-implemented method of claim 14, further comprising determining the set of the grids based on motion, color, and visual patterns associated with the visual information of two or more grids of the successive frames.

16. The computer-implemented method of claim 10, wherein determining a set of grids that present non-intrusive visual data of the video further comprises applying a Gaussian filter to determine a contrast in a portion of the video in two or more grids of a same frame.

17. The computer-implemented method of claim 10, wherein the file, upon execution on a client computing device, effectuates displaying the video and the advertisement in the advertisement template in the grids for the length of time.

18. The computer-implemented method of claim 10, wherein the text-based advertisement is selected based on keywords related to metadata associated with the video.

19. One or more computer-readable media embodied with computer-executable instructions that, when executed by a processor, display a graphical user interface on a presentation device for rendering a text-based advertisement in a video, the graphical user interface comprising:
an advertisement display area displaying, on a display device, an advertisement in an advertisement template, the advertisement region identified in a plurality of frames of the video, the plurality of frames selected by analyzing color, contrast, and motion associated with visual data in each of the plurality of frames; and
a rendered video display area displaying, on the display device, the video with the advertisement.

20. The one or more media of claim 19, wherein the advertisement region is presented as an overlay on the video region.
